(19) United States
(12) Patent Application Publication
(10) Pub. No.: US 2026/0187397 A1
(43) Pub. Date: Jul. 2, 2026

(54) CARD READER AND CARD LOCKING MECHANISM THEREOF

(71) Applicant: NIDEC INSTRUMENTS CORPORATION, Nagano (JP)

(72) Inventor: Ryo Uchiyama, Nagano (JP)

(73) Assignee: NIDEC INSTRUMENTS CORPORATION, Nagano (JP)

(21) Appl. No.: 19/002,743

(22) Filed: Dec. 27, 2024

(51) Int. Cl. G06K 13/08

(52) U.S. Cl. CPC G06K 13/085; G06K 13/0806

(57) ABSTRACT

A card reader includes a card insertion port, a card transport path, a card locking mechanism. The card locking mechanism includes a motor, a locking member for contacting a card to prevent the card from being removed from the card insertion port. A power transmission mechanism includes a gear train, the gear train includes a worm gear, a first gear, a second gear, a clutch rotation shaft having a clutch rotation axis. The clutch rotation shaft is configured to rotate at least two gears included in the gear train around the clutch rotation axis. A clutch mechanism is configured to engage and disengage power transmission between the motor and the locking member. The clutch mechanism is configured such that one gear among the two gears rotating around the clutch rotation axis is decouplable from the clutch rotation shaft to disengage power transmission between the motor and the locking member.

### BACKGROUND OF THE DISCLOSURE

### Technical Field

The disclosure relates to a card reader and a card locking mechanism, and more specifically relates to a release of a locked state of the card locking mechanism.

### Related Art

Conventionally, a card reader includes a card locking mechanism. The card locking mechanism prevents a card from being removed from a card insertion port of the card reader. The card locking mechanism includes a worm gear assembly having a worm and a worm wheel. When the worm is rotated in a first direction by, for example a motor, the card locking mechanism is forced into a locked state in which the card is prevented from being removed from the card insertion port. In the worm gear assembly, the worm wheel can be rotated by rotating the worm, however, the worm can not be rotated by rotating the worm wheel.

Patent literature 1 and Patent literature 2 disclose a knob connected to the worm to release the locked state of the card locking mechanism. Specifically, the knob is manually rotated by a user such that the worm connected to the knob is rotated in a second direction opposite to the first direction to force the card locking mechanism into an unlocked state in which the card is not prevented from being removed from the card insertion port.

### LITERATURE OF RELATED ART

### Patent literature

Patent Literature 1: Japanese Laid-open No. 2016-224830

Patent Literature 2: Japanese Laid-open No. 2023-020672

However, when the knob is connected directly to the worm such as disclosed in Patent literature 1 and Patent literature 2, a layout of the card reader may become limited. In addition, when the knob is connected directly to the worm, a deceleration of the worm by the worm wheel becomes large and turning the worm (via the knob) too much may cause damage to the worm gear assembly.

Therefore, a way to improve a flexibility in the layout of the card reader having the card locking mechanism is needed. In addition, a way for reducing damage to the worm gear assembly is needed.

### SUMMARY

According to an embodiment of the disclosure, a card reader includes a card insertion port for inserting a card; a card transport path for transporting the card; a card locking mechanism for preventing the card from being removed from the card insertion port, the card locking mechanism having a locked state in which the card is prevented from being removed from the card insertion port and an un-locked state in which the card is not prevented from being removed from the card insertion port. The card locking mechanism includes a motor; a locking member including a claw for contacting the card to prevent the card from being removed from the card insertion port; a power transmission mechanism including a gear train providing power transmission from the motor to the locking member. The gear train includes a worm gear including a worm and a worm wheel meshing with the worm; a first gear, providing power transmission from the worm gear to the locking member; a second gear, providing power transmission from the worm gear to the locking member; a clutch rotation shaft having a clutch rotation axis, the clutch rotation shaft is configured to rotate at least two gears included in the gear train around the clutch rotation axis; a clutch mechanism configured to engage and disengage power transmission between the motor and the locking member; an operation part, configured to release the locked state of the card locking mechanism by manually disengaging power transmission between the motor and the locking member. The clutch mechanism is configured such that one gear among the two gears rotating around the clutch rotation axis is decouplable from the clutch rotation shaft to disengage power transmission between the motor and the locking member.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a schematic cross-sectional view of a card reader according to an embodiment of the disclosure;

FIG. 2 is a perspective view of a card locking mechanism of the card reader according to an embodiment of the disclosure;

FIG. 3 is a side view of the card locking mechanism of FIG. 2 in an unlocked state according to an embodiment of the disclosure;

FIG. 4 is a side view of the card locking mechanism of FIG. 2 in a locked state according to an embodiment of the disclosure;

FIG. 5 is a perspective view of the card locking mechanism according to an embodiment of the disclosure;

FIG. 6 is a perspective view of the card locking mechanism with a second plate omitted according to an embodiment of the disclosure;

FIG. 7 is a perspective view of the card locking mechanism with a second plate and a spacer omitted according to an embodiment of the disclosure;

FIG. 8 is a perspective view of a clutch mechanism in a disengaged state according to an embodiment of the disclosure;

FIG. 9 is a plan view of the clutch mechanism in a disengaged state according to an embodiment of the disclosure;

FIG. 10 is a plan view of the clutch mechanism in an engaged state according to an embodiment of the disclosure;

FIG. 11 is a sectional view of the clutch mechanism in an engaged state according to an embodiment of the disclosure;

FIG. 12 is a sectional view of the clutch mechanism in an engaged state according to an embodiment of the disclosure;

FIG. 13 is a sectional view of the clutch mechanism in a disengaged state according to an embodiment of the disclosure;

FIG. 14 is a sectional view of the clutch mechanism in a disengaged state according to an embodiment of the disclosure;

FIG. 15 is a schematic diagram illustrating a configuration of a gear side protrusion and a rotation shaft side pin according to an embodiment of the disclosure;

FIG. 16 is a schematic diagram illustrating a configuration of a gear side protrusion and a rotation shaft side pin according to another embodiment of the disclosure;

FIG. 17 is a perspective view of a clutch mechanism according to another embodiment wherein a worm wheel is rotated around a rotation shaft having a rotation axis that is different from the clutch rotation shaft.

### DESCRIPTION OF THE EMBODIMENTS

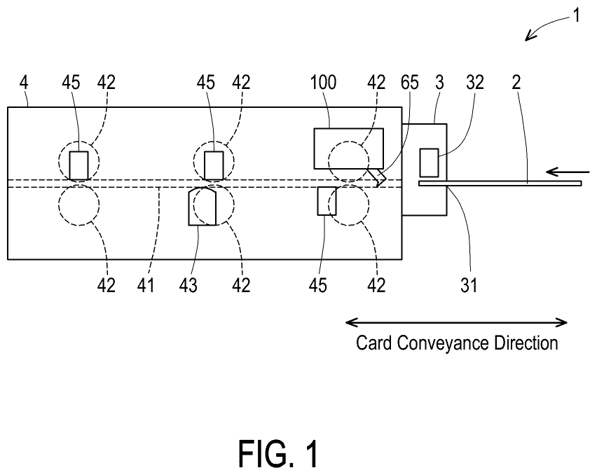

FIG. 1 is a schematic cross-sectional view of a card reader according to an embodiment of the disclosure. Referring to FIG. 1, a card reader 1 is provided. The card reader 1 may be, for example, a card reader in which various processing including at least one of reading or writing of data are performed on a card 2. The card 2 may be, for example, a substrate, a magnetic card, an IC card, and the like. The card reader 1 may be used, for example, in an automated teller machine (ATM). However, the disclosure is not limited thereto, and the card reader 1 may be used according to requirements.

Referring to FIG. 1, the card reader 1 includes a control unit (not shown) including a processor, an insertion part 3 into which the card 2 is inserted by a user, and a main body part 4 which is connected with the insertion part 3 and in which the card 2 inserted into the insertion part 3 is taken into the inside to perform various processing on the card 2. The insertion part 3 is provided with a card insertion port 31 for inserting the card 2. The insertion port 31 is an opening into which the card 2 is inserted and from which the card 2 is ejected and, in addition, the insertion part 3 is attached with an insertion detection sensor 32 which detects whether the card 2 is inserted into the insertion part 3 through the card insertion port 31 or not. The insertion detection sensor 32 may be structured, for example, so as to detect the card 2 having been inserted by shading an optical path between a light emitting part and a light receiving part by the card 2, or may be structured of another type of a sensor.

Referring to FIG. 1, an inside of the main body part 4 is provided with a card transport path 41, a plurality of conveyance rollers 42, a magnetic head 43, a plurality of card detection sensors 45 and a card locking mechanism 100. The card transport path 41 transports the card 2 when processing is to be performed on the card 2. The plurality of conveyance rollers 42 are provided along the card transport path 41 for conveying the card 2. The magnetic head 43 may be provided at a substantially center location in a longitudinal direction of the card transport path 41. The plurality of card detection sensors 45 are provided along the card transport path 41 for detecting an object such as the card 2. The conveyance rollers 42 are driven by a conveyance motor (not shown). The conveyance rollers 42 are rotated through rotation of the conveyance motor, such that the card 2 may be conveyed in the right and left direction in FIG. 1 in the main body part 4. In the present embodiment of FIG. 1, three pairs of the conveyance rollers 42 are provided, and three card detection sensors 45 are provided. However, the disclosure is not limited thereto and a number of the conveyance rollers 43, and a number of the card detection sensors 45 may each be set according to requirements. The card detection sensor 45 may be, for example, an optical type sensor which detects an object by shading an optical path with the object may be utilized, or a capacitance type sensor which detects an object by detecting an electrostatic capacitance change. In the present embodiment, the card locking mechanism 100 is disposed on an upper side of the card transport path 41. However, the disclosure is not limited thereto, and in another embodiment of the disclosure, the card locking mechanism 100 may be disposed on a lower side of the card transport path 41.

Referring to FIG. 1, the card locking mechanism 100 prevents the card 2 from being removed from the card insertion port 31. More specifically, the card locking mechanism 100 may prevent pulling-out of the card 2 from the card insertion port 31 in any case, for example, when the card reader 1 detects that the card 2 is jammed in the card transport path 41, when the card reader detects a shutter (not shown) provided in the card insertion port 31 is forcibly opened, when the card reader 1 detects a forcible movement of the card 2 in the card transport path 41 that is operated from the outside, when the card reader 1 detects an abnormal change in various sensors provided in the card transport path 41, and/or the like.

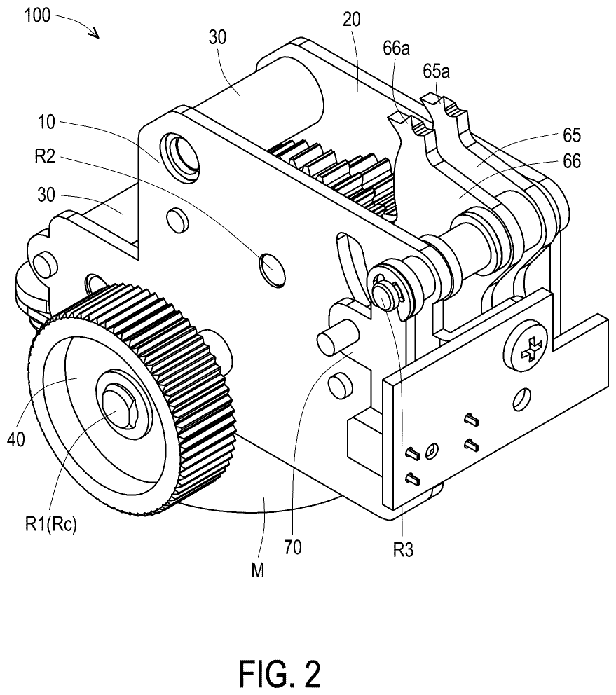

FIG. 2 is a perspective view of a card locking mechanism of the card reader according to an embodiment of the disclosure. Referring to FIG. 2, the card locking mechanism 100 includes a motor M, a first plate 10, a second plate 20, a plurality of bars 30, a knob 40, a first locking member 65, a second locking member 66, a first rotation shaft R1, a second rotation shaft R2, and a third rotation shaft R3. The motor M may be, for example, a stepper motor, a servo motor, a dc motor, an AC motor, and/or the like. The first locking member 65 may include a first claw 65a configured to contact the card 2. The second locking member 66 may include a second claw 66a configured to contact the card 2. The first locking member 65 and the second locking member 66 are each an example of a locking member of the disclosure. A number of the locking members may be set according to requirements. The first claw 65a and the second claw 66a are each an example of a claw of the disclosure. In the present embodiment, the first claw 65a and the second claw 66a are shown to have pointed shapes. However, the disclosure is not limited thereto and the shape of the claws 65a, 66a may be set according to requirements. For example, the claw 65a, 66a may be not pointed, and for example may have a rounded shape, a smooth shape, and/or the like.

Referring to FIG. 2, the second plate 20 is disposed facing the first plate 10. The plurality of bars 30 are disposed between the first plate 10 and the second plate 20. The plurality of bars 30 may be used to fix a position of the first plate 10 relative to a position of the second plate 20. The plurality of bars 30 may fix the first plate 10 to the second plate 20 via fasteners, for example, nuts and bolts. A distance between the first plate 10 and the second plate 20 may be set according to requirements and is not intended to limit the disclosure. A number of the plurality of bars 30 may be set according to requirements and is not intended to limit the disclosure. Each cross-section of the plurality of bars 30 may be any shape, for example, circular, oval, triangular, square, polygonal and the like. A shape of the cross-section of each of the plurality of bars 30 may be set according to requirements and is not intended to limit the disclosure.

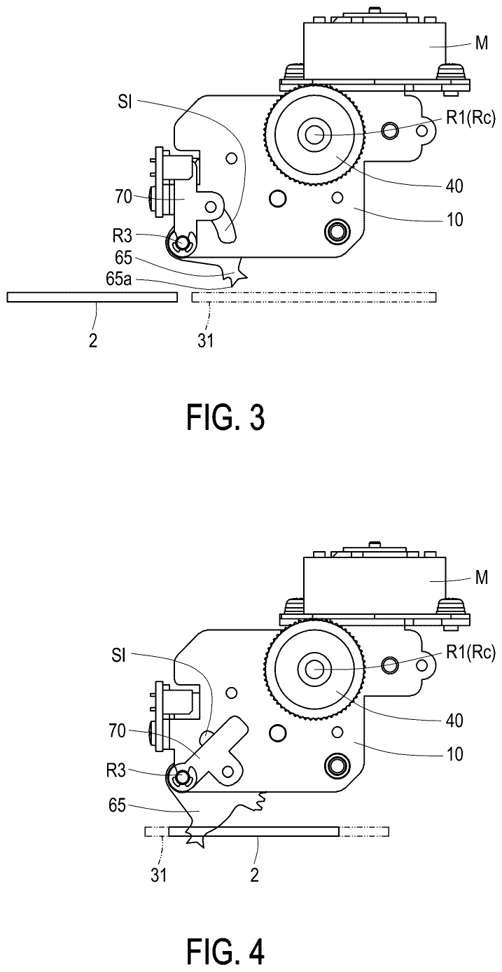

FIG. 3 is a side view of the card locking mechanism of FIG. 2 in an unlocked state according to an embodiment of the disclosure. Referring to FIG. 3, when the motor M is driven and rotated in a first direction, the card locking mechanism 100 is forced into an un-locked state in which the card 2 is not prevented from being removed from the card insertion port 31. More specifically, in response to the motor M being driven in the first direction, the locking member 65 is retracted from the card transport path 41. A bracket 70 is fixed to the locking member 65, wherein the locking member 65 and the bracket 70 both rotate around the third rotation shaft R3. The bracket 70 includes a pin (not shown) protruding from the bracket 70. The pin of the bracket 70 slides inside a slit Sl. The pin of the bracket 70 which is guided by the slit Sl may limit a retraction position of the locking member 65. In other words, the retraction position of the claw 65a may be controlled via a rotation of the motor M using the control unit, while the pin of the bracket 70 and the slit Sl may act as a hard stop. In the present embodiment, the slit Sl is provided on the first plate 10. However, the disclosure is not limited thereto, and in another embodiment of the disclosure the slit Sl may be provided on the second plate 20.

FIG. 4 is a side view of the card locking mechanism of FIG. 2 in a locked state according to an embodiment of the disclosure. Referring to FIG. 4, when the motor M is driven and rotated in a second direction opposite to the first direction, the card locking mechanism 100 is forced into a locked state in which the card 2 is prevented from being removed from the card insertion port 31. More specifically, in response to the motor M being driven in the second direction, the locking member 65 protrudes into the card transport path 41, such that the claw 65a contacts the card 2 to prevent the card 2 from being removed from the card insertion port 31. The pin of the bracket 70 which is guided by the slit Sl may limit a protruding position of the locking member 65. In other words, the protruding position of the claw 65a may be controlled via a rotation of the motor M using the control unit, while the pin of the bracket 70 and the slit Sl may act as a hard stop. In this way, even in a case when the card 2 is being forcibly removed from the card insertion port 31 while the card locking mechanism 100 is in the locked state, the locking member 65 may be prevented from further rotation due to the hard stop between the pin of the bracket 70 and the slit Sl.

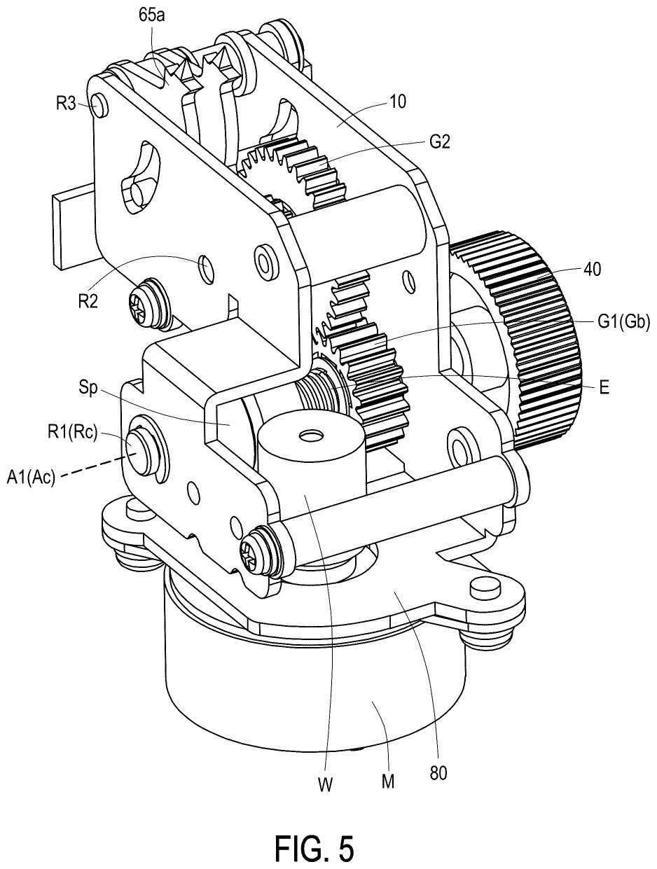

FIG. 5 is a perspective view of the card locking mechanism according to an embodiment of the disclosure. Referring to FIG. 5, the card locking mechanism 100 includes a power transmission mechanism. The power transmission mechanism includes a gear train that provides power transmission from the motor M to the locking member 65. For example, a rotation of the motor M may be transmitted to a rotation of the locking member 65. For example, a movement of the motor M may be transmitted to a movement of the locking member 65.

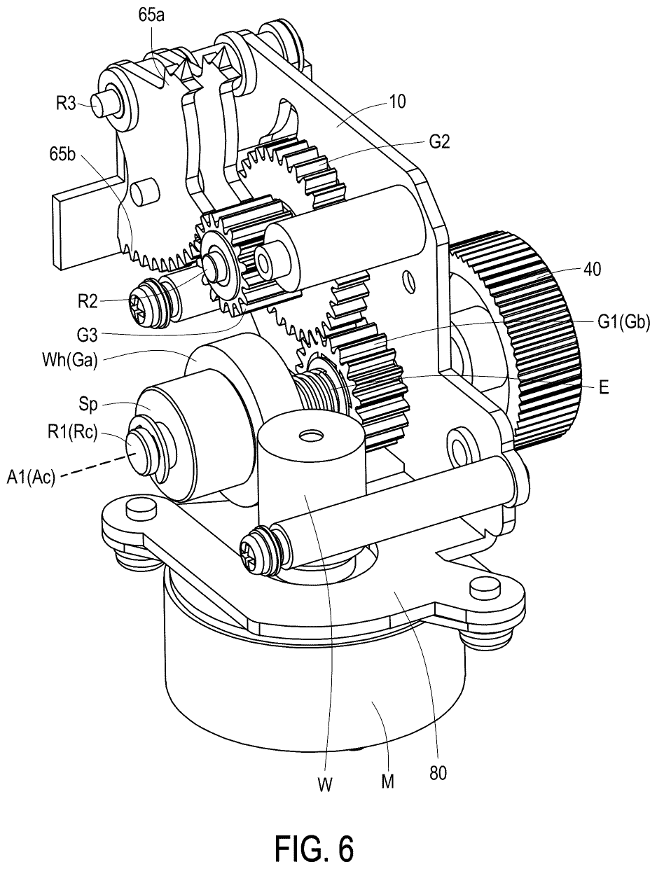

FIG. 6 is a perspective view of the card locking mechanism with a second plate omitted according to an embodiment of the disclosure. Referring to FIG. 6, the second plate 20 is omitted for a better view of the gear train. The gear train includes a worm gear having a worm W, and a worm wheel Wh meshing with the worm W. The gear train further includes a first gear G1 providing power transmission from the worm gear to the locking member 65, a second gear G2 providing power transmission from the worm gear to the locking member 65, a third gear G3 providing power transmission from the worm gear to the locking member 65, and teeth 65b of the locking member 65 providing power transmission from the worm gear to the locking member 65. Teeth 65b of the locking member 65 mesh with teeth of the third gear G3. The first rotation shaft R1 has a first rotation axis A1. The second rotation shaft has a second rotation axis A2. In the present embodiment, the first rotation shaft R1 is an example of a clutch rotation shaft Rc of the disclosure, and the first rotation axis A1 is an example of a clutch rotation axis Ac of the disclosure. The clutch rotation shaft R1(Rc) is configured to rotate at least two gears Ga, Gb included in the gear train around the clutch rotation axis A1(Ac). In the present embodiment, the at least two gears Ga, Gb rotated around the clutch rotation axis A1(Ac) are the worm wheel Wh and the first gear G1. That is to say, in the present embodiment, the clutch rotation shaft R1(Rc) is configured to rotate the worm wheel Wh and the first gear G1 around the clutch rotation axis A1(Ac) as the at least two gears Ga, Gb. In the present embodiment, the worm wheel Wh is an example of a clutch gear of the disclosure.

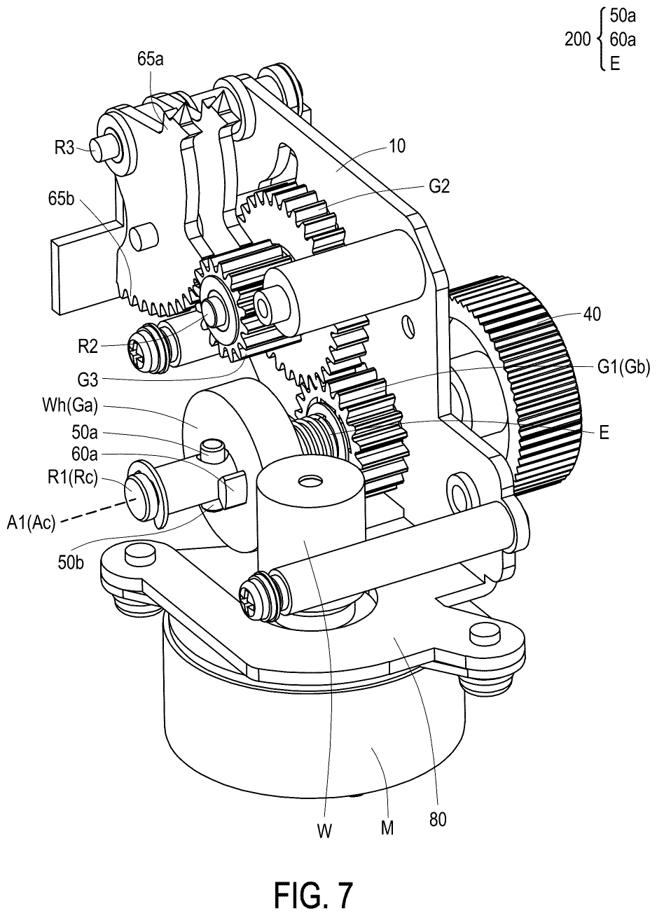

FIG. 7 is a perspective view of the card locking mechanism with a second plate and a spacer omitted according to an embodiment of the disclosure. Referring to FIG. 7, the second plate 20 and the spacer SP are omitted for a better view of a clutch mechanism 200. The clutch mechanism 200 includes a clutch rotation shaft side pin 50a, a gear side protrusion 60a, and an elastic member E. The clutch rotation shaft side pin 50a is disposed on the clutch rotation shaft R1(Rc). The clutch rotation shaft side pin 50a protrudes toward a radial direction of the clutch rotation shaft R1(Rc). The clutch mechanism 200 is configured such that a clutch gear Ga among the two gears Ga, Gb rotating around the clutch rotation axis R1(Rc) is decouplable from the clutch rotation shaft R1(Rc) to disengage power transmission between the motor M and the locking member 65. In the present embodiment, the clutch gear Ga configured to be decouplable from the clutch rotation shaft R1(Rc) is the worm wheel Wh. In other words, the worm wheel Wh(Ga) among the two gears Wh(Ga), G1(Gb) is decouplable from the clutch rotation shaft R1(Rc) to disengage power transmission between the motor M and the locking member 65. The worm wheel Wh may rotate with respect to the clutch rotation shaft R1(Rc) when the worm wheel Wh is decoupled from the clutch rotation shaft R1(Rc). In other words, the worm wheel Wh may rotate relative to the clutch rotation shaft R1(Rc) when the worm wheel Wh is decoupled from the clutch rotation shaft R1(Rc). The gear side protrusion 60a is disposed on the worm wheel Wh(Ga) that is decouplable from the clutch rotation shaft R1(Rc).

Referring to FIG. 7, when the worm wheel Wh is rotated by the worm W, the gear side protrusion 60a of the worm wheel Wh is configured to abut the clutch rotation shaft side pin 50a of the clutch rotation shaft R1(Rc) to rotate the clutch rotation shaft R1(Rc). In the present embodiment, another gear Gb among the two gears Ga, Gb rotating around the clutch rotation axis A1(Ac) is the first gear G1. The second gear G2 rotates about the second rotation axis A2 different from the clutch rotation axis A1(Ac). In the present embodiment, the second rotation axis A2 is an example of another rotation axis of the disclosure.

The clutch mechanism 200 is configured to engage and disengage power transmission between the motor M and the locking member 65 via an operation part 40. The operation part 40 may be, for example, a knob. The operation part 40 may be, for example an extension of the clutch rotation shaft R1(Rc). A diameter of the operation part 40 may be larger, smaller or the same as a diameter of the clutch rotation shaft R1(Rc). A circumferential surface of the operation part 40 may be a smooth surface, an uneven surface, a knurled surface, and/or the like. The operation part 40 is configured to be pressed and/or manually rotated by a user.

Referring to FIG. 7, in the present embodiment, the worm W is fixed to an output shaft of the motor M. However, the disclosure is not limited thereto. In another embodiment of the disclosure, the worm W may be fixed to another shaft different from the output shaft of the motor M. For example, the worm W may be fixed to the another shaft that is parallel, perpendicular, or at an angle with respect to the output shaft of the motor M.

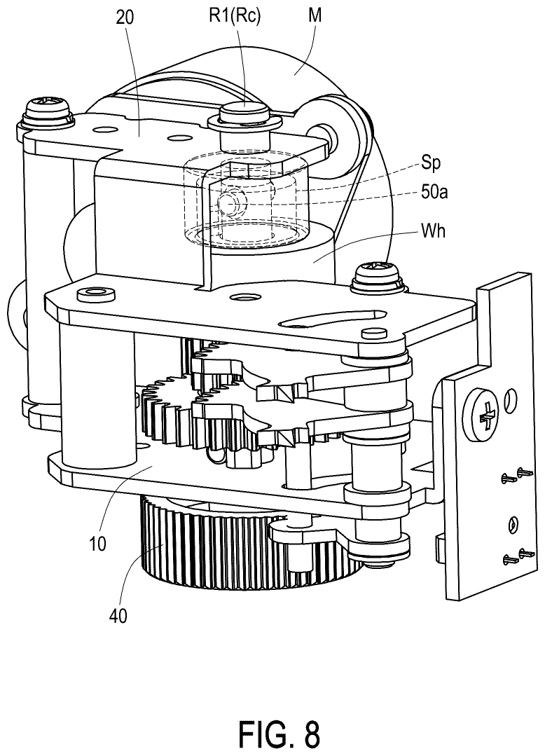

FIG. 8 is a perspective view of a clutch mechanism in a disengaged state according to an embodiment of the disclosure. Referring to FIG. 8, the spacer Sp is shown in a transparent manner for a better view of the clutch rotation shaft side pin 50a. The worm wheel Wh includes a worm wheel hole disposed at a center of the worm wheel Wh. The clutch rotation shaft R1(Rc) is inserted in the worm wheel hole of the worm wheel Wh. In more detail, the clutch rotation shaft R1(Rc) is inserted in the worm wheel hole of the worm wheel Wh, however the worm wheel Wh is not fixed to the clutch rotation shaft R1(Rc). For example, a set screw is not used to fix the worm wheel Wh to the clutch rotation shaft R1(Rc). In this way, the clutch rotation shaft R1(Rc) may be configured such that in a case when the operation part 40 is pressed, the clutch mechanism 200 disengages power transmission between the worm wheel Wh and the clutch rotation shaft R1(Rc) via the clutch rotation shaft R1(Rc) sliding inside the worm wheel hole of the worm wheel Wh in the clutch rotation axis A1(Ac) direction such that the clutch rotation shaft side pin 50a disengages from the gear side protrusion 60a so that the worm wheel Wh is rotatable around the clutch rotation shaft R1(Rc).

Referring to FIG. 8, the worm wheel Wh may be decoupled from the clutch rotation shaft R1(Rc) when a position of the clutch rotation shaft side pin 50a is different from a position of the gear side protrusion 60a in the clutch rotation axis A1(Ac) direction of the clutch rotation shaft R1(Rc). In more detail, the worm wheel Wh may be decoupled from the clutch rotation shaft R1(Rc) when a position of the clutch rotation shaft side pin 50a does not overlap with a position of the gear side protrusion 60a in the clutch rotation axis A1(Ac) direction of the clutch rotation shaft R1(Rc). After the worm wheel Wh is decoupled from the clutch rotation shaft R1(Rc) by pressing the operation part 40 to disengage the clutch rotation shaft side pin 50a from the gear side protrusion 60a, now the clutch rotation shaft R1(Rc) can be rotated (for example, by a user via the operation part 40) more than 360 degrees without the clutch rotation shaft side pin 50a abutting the gear side protrusion 60a of the worm wheel Wh. In this way, the clutch mechanism 200 is disengaged so that obstruction/resistance from the worm wheel Wh may be prevented when the clutch rotation shaft R1(Rc) is rotated. Accordingly, in a case when the operation part 40 is pressed, the worm wheel Wh is configured to be rotatable relative to the clutch rotation shaft R1(Rc). However, even when the worm wheel Wh is not decoupled from the clutch rotation shaft R1(Rc), the worm wheel Wh may still rotate relative to the clutch rotation shaft R1(Rc), but not more than 360 degrees since the clutch rotation shaft side pin 50 a will abut the gear side protrusion 60a.

Referring to FIG. 8, the spacer Sp is disposed between the second plate 20 and the worm wheel Wh. The spacer Sp is configured to abut against the worm wheel Wh such that the worm wheel does not slide together with the clutch rotation shaft R1(Rc) in the clutch rotation axis A1(Ac) direction. In the present embodiment, the spacer Sp has a hollow cylindrical shape, or a ring shape, wherein the clurtch rotation shaft R1(Rc) is inserted through the hollow portion of the spacer Sp. However, the disclosure is not limited thereto, and a shape of the spacer Sp may be set according to requirements. A lubricant, for example, grease or oil, may be disposed between the worm wheel hole of the worm wheel Wh and the clutch rotation shaft R1(Rc) to improve the sliding of the clutch rotation shaft R1(Rc) relative to the worm wheel Wh.

Referring to FIG. 7, the first gear G1 is fixed to the clutch rotation shaft R1(Rc) by, for example, a set screw. In this way, the first gear G1 rotates together with the clutch rotation shaft R1(Rc), and the first gear G1 does not rotate relative to the clutch rotation shaft R1(Rc) even when the worm wheel Wh rotates relative to the clutch rotation shaft R1(Rc). Therefore, when the operation part 40 is pressed in the clutch rotation axis A1(Ac) direction, the first gear G1 fixed to the clutch rotation shaft R1(Rc) also moves in the clutch rotation axis A1(Ac) direction. Therefore, a first distance between the two gears Ga(Wh), Gb(G1) in a state when the clutch mechanism 200 is engaged is larger than a second distance between the two gears Ga(Wh), Gb(G1) in a state when the clutch mechanism 200 is disengaged.

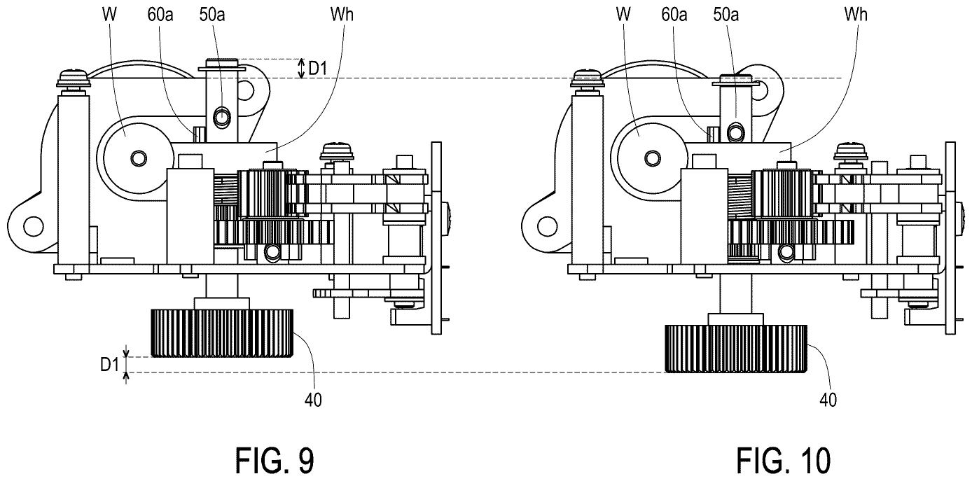

FIG. 9 is a plan view of the clutch mechanism in a disengaged state according to an embodiment of the disclosure. Referring to FIG. 9, when the operating part 40 is pressed, a tip of the clutch rotation shaft R1(Rc) that is away from the operating part 40 moves by a first distance D1. The first distance D1 may be, for example, 8 mm, 10 mm, 14 mm, 20 mm, 40 mm, and/or the like. However, the disclosure is not limited thereto and the first distance D1 may be set according to requirements. It should be noted, in a state when the worm wheel Wh is disengaged from the clutch rotation shaft R1(Rc) by pressing the operation part 40, an engagement between teeth of the first gear G1 and teeth of the second gear G2 is still maintained. For example, the first distance D1 may be less than or equal to a height (a face width) of the first gear G1, and/or the first distance D1 may be less than or equal to a height (a face width) of the second gear G2. By maintaining the engagement between the teeth of the first gear G1 and the teeth of the second gear G2 when the clutch mechanism 200 is disengaged, the operation part 40 can be rotated to release the locked state of the locking member 65 of the card locking mechanism 100. That is to say, the operating part 40 is rotated such that the locking member 65 is retracted from the card transport path 41.

FIG. 10 is a plan view of the clutch mechanism in an engaged state according to an embodiment of the disclosure. When the operating part 40 is not pressed, the tip of the clutch rotation shaft R1(Rc) that is away from the operating part 40 is pushed back to an original position shown in FIG. 10 by the elastic member E. The elastic member E is disposed between the worm wheel Wh and the first gear G1, and the elastic member E biases the first gear G1 in a direction away from the worm wheel Wh. In the present embodiment, the elastic member E is a spring. More specifically, in the present embodiment, the elastic member E is a compression coil spring. A spring constant k of the spring may be set so as to be compressible by a user. In an embodiment of the disclosure, a spring constant k of the spring may be, for example, 50, 100, 300, 500 newton/meter and/or the like. However, the disclosure is not limited thereto, and the spring constant k may be set according to requirements.

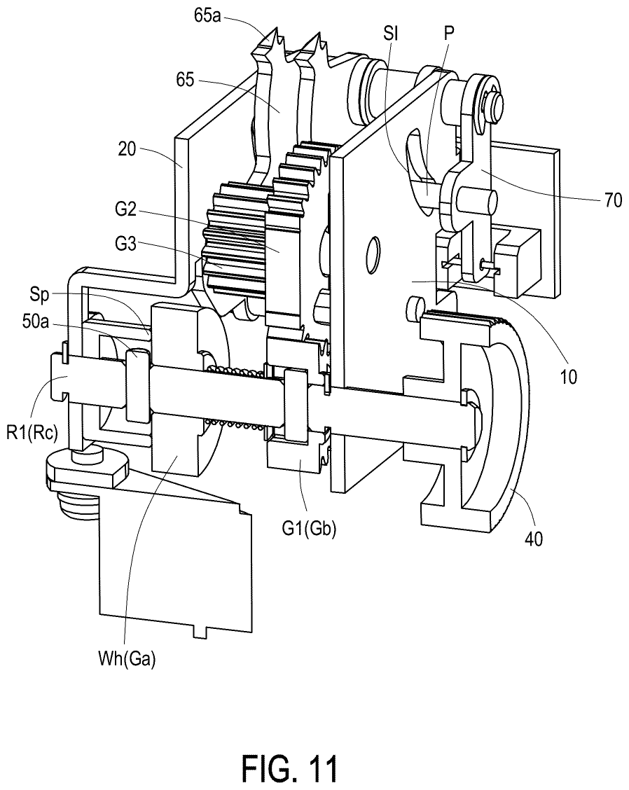

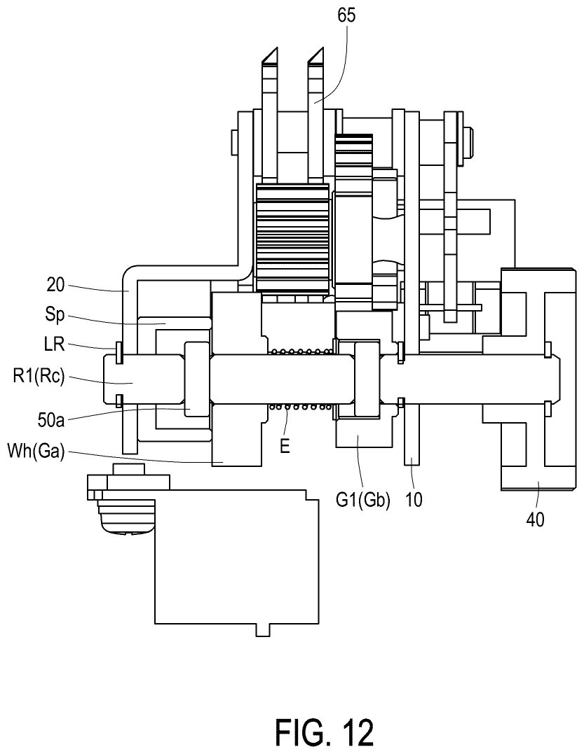

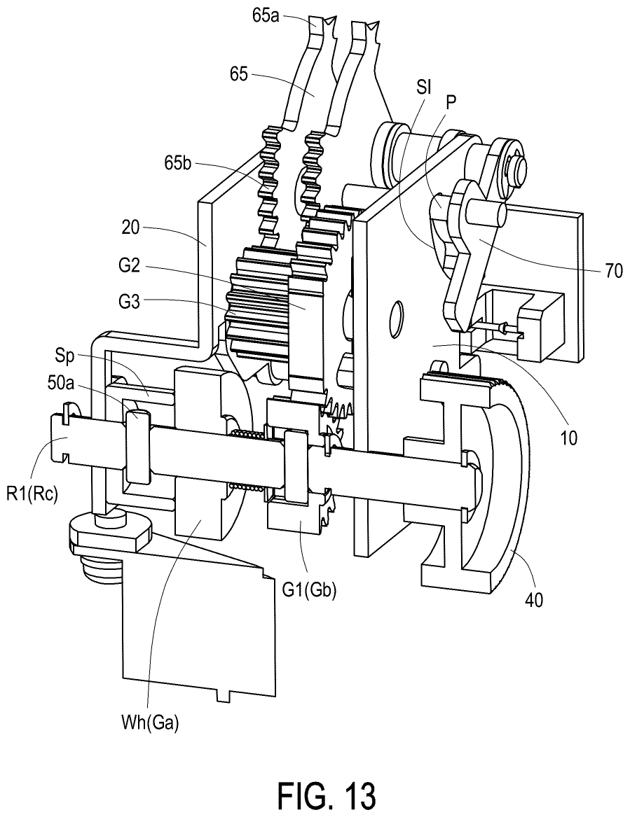

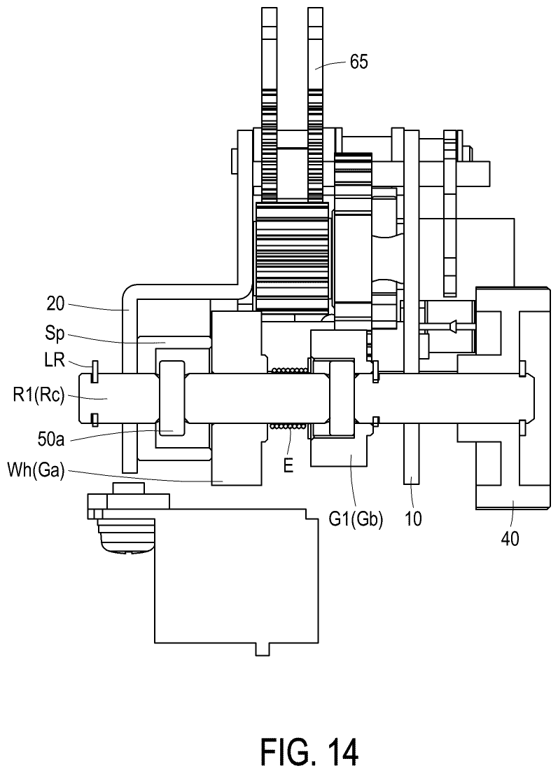

FIG. 11 is a sectional view of the clutch mechanism in an engaged state according to an embodiment of the disclosure. FIG. 12 is a sectional view of the clutch mechanism in an engaged state according to an embodiment of the disclosure. FIG. 13 is a sectional view of the clutch mechanism in a disengaged state according to an embodiment of the disclosure. FIG. 14 is a sectional view of the clutch mechanism in a disengaged state according to an embodiment of the disclosure. Referring to FIG. 11-FIG. 14, when the operation part 40 is pressed, the clutch rotation shaft side pins 50a may be configured to abut an inner surface of the spacer Sp to limit a sliding amount of the clutch rotation shaft R1(Rc) when the operation part 40 is pressed. In addition, the clutch rotation shaft R1(Rc) may include a lock ring LR so that the clutch rotation shaft R1(Rc) does not slide out of the second plate 20 when the elastic member E biases the first gear G1 away from the worm wheel Wh.

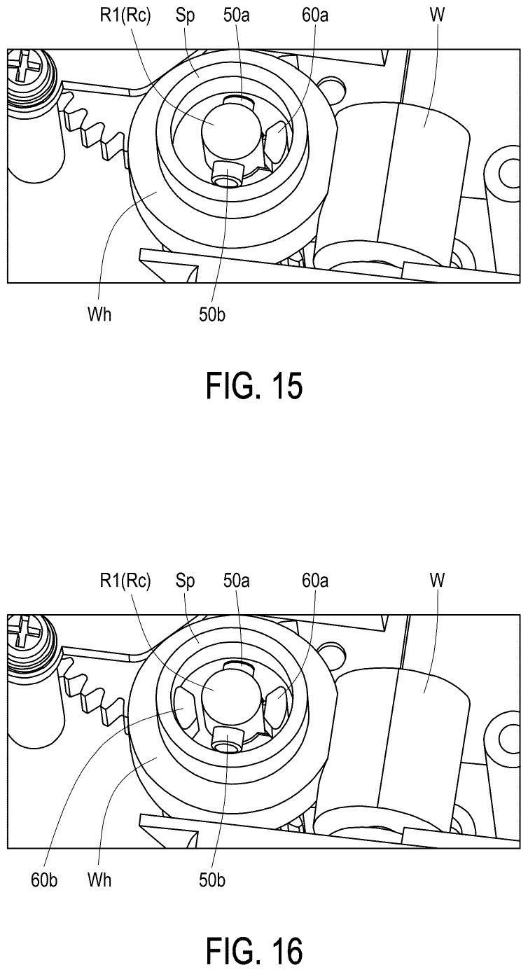

FIG. 15 is a schematic diagram illustrating a configuration of a gear side protrusion and a rotation shaft side pin according to an embodiment of the disclosure. The present embodiment includes two clutch rotation shaft side pins 50a, 50b. However, the disclosure is not limited thereto, and a number of the clutch rotation shaft side pins may be set according to requirements. For example, in another embodiment of the disclosure, the clutch rotation shaft R1(Rc) may include only the first clutch rotation shaft side pin 50a, and the second clutch rotation shaft side pin 50b may be omitted. In another embodiment of the disclosure, the clutch rotation shaft R1(Rc) may include three or more clutch rotation shaft side pins. In the present embodiment, the first clutch rotation shaft side pin 50a and the second clutch rotation shaft side pin 50b each have a substantially cylindrical shape. However, the disclosure is not limited thereto and a shape of the clutch rotation shaft side pin may be set according to requirements. For example, in another embodiment of the disclosure, the clutch rotation shaft side pin 50a, 50b may have a triangle shape, a rectangle shape, a polygonal shape, and/or the like.

Referring to FIG. 15, the present embodiment includes one gear side protrusion 60a. However, the disclosure is not limited thereto, and a number of the gear side protrusions may be set according to requirements. For example, in another embodiment of the disclosure, the worm wheel Wh may include two or more gear side protrusions. In the present embodiment, the first gear side protrusion 60a has a substantially trapezoidal shape. However, the disclosure is not limited thereto and a shape of the first gear side protrusion 60a may be set according to requirements. For example, in another embodiment of the disclosure, the first gear side protrusion 60a may have a triangle shape, a cylindrical shape, a rectangle shape, a polygonal shape, and/or the like. A first surface of the first gear side protrusion 60a abuts a second surface of the first clutch rotation shaft side pin 50a. A contour of the first surface may be the same as a contour of the second surface. In other words, the contour of the first surface may match the contour of the second surface to increase a meshing area between the first gear side protrusion 60a and the first clutch rotation shaft side pin 50a to improve rotation efficiency.

FIG. 16 is a schematic diagram illustrating a configuration of a gear side protrusion and a rotation shaft side pin according to another embodiment of the disclosure. FIG. 16 shows an embodiment of the disclosure wherein the clutch mechanism 200 includes two clutch rotation shaft side pin 50a, 50b and two gear side protrusion 60a, 60b.

An embodiment of the disclosure was described in FIG. 2-FIG. 14 where the worm wheel Wh is rotated around the clutch rotation shaft Rc. However, the disclosure is not limited thereto. In another embodiment of the disclosure, the worm wheel Wh may rotate around a rotation shaft having a rotation axis that is different from the clutch rotation shaft Rc.

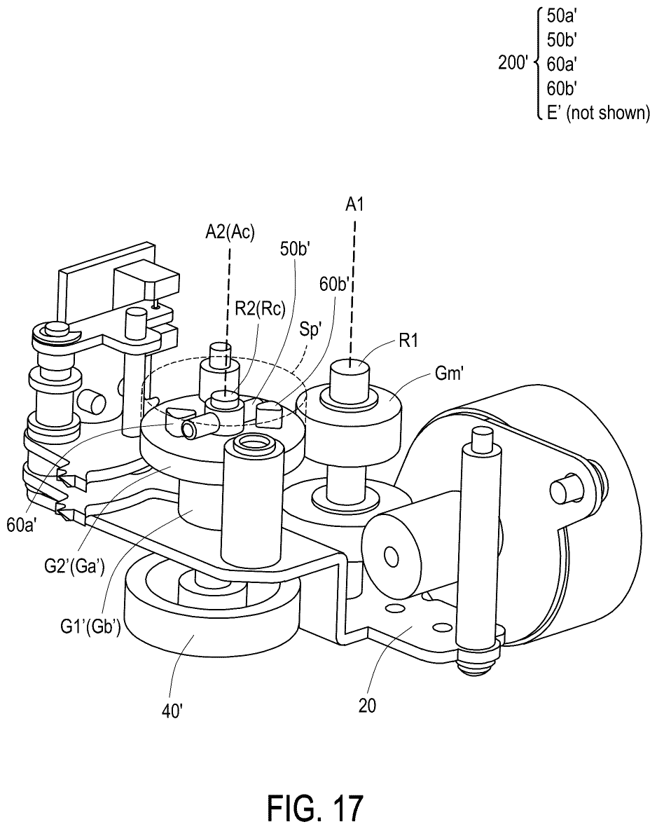

FIG. 17 is a perspective view of a clutch mechanism according to another embodiment wherein a worm wheel is rotated around a rotation shaft having a rotation axis that is different from the clutch rotation shaft. Referring to FIG. 17, a clutch mechanism 200′ is shown. The worm wheel Wh rotates around a rotation shaft R1 having a rotation axis A1 that is different from the clutch rotation axis Ac. In the present embodiment, the first rotation axis A1 is an example of another rotation axis of the disclosure.

Referring to FIG. 17, the second rotation shaft R2 is an example of a clutch rotation shaft Rc′ of the disclosure, and the second rotation axis A2 is an example of a clutch rotation axis Ac′ of the disclosure. The clutch rotation shaft R2(Rc′) is configured to rotate at least two gears Ga′, Gb′ included in the gear train around the clutch rotation axis A2(Ac). In the present embodiment, the at least two gears Ga′, Gb′ rotated around the clutch rotation axis A2(Ac) by the clutch rotation shaft R2(Rc) are a second gear G2′ and a first gear G1′. That is to say, in the present embodiment, the clutch rotation shaft R2(Rc) is configured to rotate the second gear G2′ and the first gear G1′ around the clutch rotation axis A2(Ac) as the at least two gears Ga, Gb. In the present embodiment, the second gear G2′ is an example of a clutch gear of the disclosure.

Referring to FIG. 17, the clutch mechanism 200′ includes a clutch rotation shaft side pin 50a′, a second clutch rotation shaft side pin 50b′, a first gear side protrusion 60a′, a second gear side protrusion 60b′. An elastic member E′ (not shown) is disposed between the second gear G2′ and the first gear G1′. The first and second clutch rotation shaft side pins 50a′, 50b′ are disposed on the clutch rotation shaft R2(Rc). The clutch rotation shaft side pins 50a′, 50b′ protrude toward a radial direction of the clutch rotation shaft R2(Rc). The clutch mechanism 200′ is configured such that a clutch gear Ga′ among the two gears Ga′, Gb′ rotating around the clutch rotation axis R2(Rc) is decouplable from the clutch rotation shaft R2(Rc) to disengage power transmission between the motor M and the locking member 65. In the present embodiment, the clutch gear Ga′ configured to be decouplable from the clutch rotation shaft R2(Rc) is the second gear G2′. In other words, the second gear G2′ among the two gears G2′(Ga′), G1′(Gb′) is decouplable from the clutch rotation shaft R2(Rc) to disengage power transmission between the motor M and the locking member 65. The second gear G2′ may rotate with respect to the clutch rotation shaft R2(Rc) when the second gear G2′ is decoupled from the clutch rotation shaft R2(Rc). In other words, the second gear G2′ may rotate relative to the clutch rotation shaft R2(Rc) when the second gear G2′ is decoupled from the clutch rotation shaft R2(Rc). The gear side protrusion 60a′, 60b′ are disposed on the second gear G2′(Ga′) that is decouplable from the clutch rotation shaft R2(Rc).

Referring to FIG. 17, when the second gear G2′ is rotated by an intermediate gear Gm′, the gear side protrusion 60a′, 60b′ of the second gear G2′ are configured to abut the clutch rotation shaft side pin 50a′ 50b′ of the clutch rotation shaft R2(Rc) to rotate the clutch rotation shaft R2(Rc). In the present embodiment, another gear Gb′ among the two gears Ga′, Gb′ rotating around the clutch rotation axis A2(Ac) is the first gear G1′. The worm wheel Wh′ rotates about a rotation axis A1 different from the clutch rotation axis A2(Ac). The clutch mechanism 200′ is configured to engage and disengage power transmission between the motor M and the locking member 65 via an operation part 40′. The operation part 40′ may be, for example, a knob. The operation part 40′ may be, for example an extension of the clutch rotation shaft R2(Rc). A diameter of the operation part 40′ may be larger, smaller or the same as a diameter of the clutch rotation shaft R2(Rc). A circumferential surface of the operation part 40′ may be a smooth surface, an uneven surface, a knurled surface, and/or the like.

Referring to FIG. 17, a spacer Sp′ is shown in a transparent manner for a better view of the clutch rotation shaft side pin 50a. The second gear G2′ includes a second gear hole disposed at a center of the second gear G2′. The clutch rotation shaft R2(Rc) is inserted in the second gear hole of the second gear G2′. In more detail, the clutch rotation shaft R2(Rc) is inserted in the second gear hole of the second gear G2′, however the second gear G2′ is not fixed to the clutch rotation shaft R2(Rc). For example, a set screw is not used to fix the second gear G2′ to the clutch rotation shaft R2(Rc). In this way, the clutch rotation shaft R2(Rc) may be configured such that in a case when the operation part 40′ is pressed, the clutch mechanism 200′ disengages power transmission between the second gear G2′ and the clutch rotation shaft R2(Rc) via the clutch rotation shaft R2(Rc) sliding inside the second gear hole of the second gear G2′ in the clutch rotation axis A2(Ac) direction such that the clutch rotation shaft side pin 50a′, 50b′ disengages from the gear side protrusion 60a′, 60b′ so that the second gear G2′ is rotatable around the clutch rotation shaft R2(Rc).

Referring to FIG. 17, the second gear G2′ may be decoupled from the clutch rotation shaft R2(Rc) when a position of the clutch rotation shaft side pin 50a′, 50b′ is different from a position of the gear side protrusion 60a′, 60b′ in the clutch rotation axis A2(Ac) direction of the clutch rotation shaft R2(Rc). In more detail, the second gear G2′ may be decoupled from the clutch rotation shaft R2(Rc) when a position of the clutch rotation shaft side pin 50a′ does not overlap with a position of the gear side protrusion 60a′ in the clutch rotation axis A2(Ac) direction of the clutch rotation shaft R2(Rc). After the second gear G2′ is decoupled from the clutch rotation shaft R2(Rc) by pressing the operation part 40′ to disengage the clutch rotation shaft side pin 50a′ from the gear side protrusion 60a′, now the clutch rotation shaft R2(Rc) can be rotated (for example, by a user via the operation part 40′) more than 360 degrees without the clutch rotation shaft side pin 50a′ abutting the gear side protrusion 60a′ of the second gear G2′. In this way, the clutch mechanism 200′ is disengaged so that obstruction/resistance from the second gear G2′ may be prevented when the clutch rotation shaft R2(Rc) is rotated. Accordingly, in a case when the operation part 40′ is pressed, the second gear G2′ is configured to be rotatable relative to the clutch rotation shaft R2(Rc). However, even when the second gear G2′ is not decoupled from the clutch rotation shaft R2(Rc), the second gear G2′ may still rotate relative to the clutch rotation shaft R1(Rc), but not more than 360 degrees (or not more than 180 degrees or not more than 90 degrees depending on a number of the gear side protrusions and/or a number of the clutch rotation shaft side pin) since the clutch rotation shaft side pin 50a′ will abut the gear side protrusion 60a′.

Referring to FIG. 17, the spacer Sp′ is disposed between the first plate 10 and the second gear G2′. The spacer Sp′ is configured to abut against the second gear G2′ such that the second gear G2′ does not slide together with the clutch rotation shaft R2(Rc) in the clutch rotation axis A2(Ac) direction. A lubricant, for example, grease or oil, may be disposed between the second gear hole of the second gear G2′ and the clutch rotation shaft R2(Rc) to improve the sliding of the clutch rotation shaft R2(Rc) relative to the second gear G2′.

Referring to FIG. 17, the first gear G1′ is fixed to the clutch rotation shaft R2(Rc) by, for example, a set screw. In this way, the first gear G1′ rotates together with the clutch rotation shaft R2(Rc), and the first gear G1′ does not rotate relative to the clutch rotation shaft R2(Rc) even when the second gear G2′ rotates relative to the clutch rotation shaft R2(Rc). Therefore, when the operation part 40′ is pressed in the clutch rotation axis A2(Ac) direction, the first gear G1′ fixed to the clutch rotation shaft R2(Rc) also moves in the clutch rotation axis A2(Ac) direction. Therefore, a first distance between the two gears Ga′(G2′), Gb′(G1′) in a state when the clutch mechanism 200′ is engaged is larger than a second distance between the two gears Ga′(G2′), Gb′(G1′) in a state when the clutch mechanism 200′ is disengaged.

Referring to FIG. 17, when the operating part 40′ is pressed, a tip of the clutch rotation shaft R2(Rc) that is away from the operating part 40′ moves by a first distance D1 similar to as shown in FIG. 9 and FIG. 10. It should be noted, in a state when the second gear G2′ is disengaged from the clutch rotation shaft R2(Rc) by pressing the operation part 40′, an engagement between teeth of the first gear G1′ and teeth 65b of the locking member 65 is still maintained. By maintaining the engagement between the teeth of the first gear G1′ and the teeth 65b of the locking member 65 when the clutch mechanism 200′ is disengaged, the operation part 40′ can be rotated to release the locked state of the locking member 65 of the card locking mechanism 100′. That is to say, the operating part 40′ is rotated such that the locking member 65 is retracted from the card transport path 41.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A card reader, comprising:
a card insertion port, for inserting a card;
a card transport path, for transporting the card;
a card locking mechanism, for preventing the card from being removed from the card insertion port, the card locking mechanism having a locked state in which the card is prevented from being removed from the card insertion port and an un-locked state in which the card is not prevented from being removed from the card insertion port, the card locking mechanism comprises:
a motor;
a locking member, including a claw for contacting the card to prevent the card from being removed from the card insertion port;
a power transmission mechanism, comprising a gear train, providing power transmission from the motor to the locking member, the gear train comprising:
a worm gear, comprising a worm, and a worm wheel meshing with the worm;
a first gear, providing power transmission from the worm gear to the locking member;
a second gear, providing power transmission from the worm gear to the locking member;
a clutch rotation shaft, having a clutch rotation axis, the clutch rotation shaft is configured to rotate at least two gears included in the gear train around the clutch rotation axis;
a clutch mechanism, configured to engage and disengage power transmission between the motor and the locking member;
an operation part, configured to release the locked state of the card locking mechanism by manually disengaging power transmission between the motor and the locking member,
wherein the clutch mechanism is configured such that a clutch gear among the two gears rotating around the clutch rotation axis is decouplable from the clutch rotation shaft to disengage power transmission between the motor and the locking member.

2. The card reader according to claim 1, wherein the clutch mechanism includes:
a gear side protrusion, disposed on the clutch gear that is decouplable from the clutch rotation shaft,
a clutch rotation shaft side pin, disposed on the clutch rotation shaft, and the clutch rotation shaft side pin protrudes toward a radial direction of the clutch rotation shaft;
wherein the gear side protrusion is configured to abut the clutch rotation shaft side pin to rotate the clutch rotation shaft.

3. The card reader according to claim 2, wherein
the clutch gear decouplable from the clutch rotation shaft is the worm wheel, and the gear side protrusion is disposed on the worm wheel,
another gear among the two gears rotating around the clutch rotation axis is the first gear, and
the second gear rotates about another rotation axis different from the clutch rotation axis.

4. The card reader according to claim 3, wherein
the worm is fixed to an output shaft of the motor, and
the worm wheel rotates relative to the clutch rotation shaft, and the worm wheel is configured to rotate the clutch rotation shaft via the gear side protrusion of the worm wheel abutting the clutch rotation shaft side pin of the clutch rotation shaft.

5. The card reader according to claim 4, wherein
the first gear is fixed to the clutch rotation shaft, and
an elastic member, is disposed between the worm wheel and the first gear, and the elastic member biases the first gear in a direction away from the worm wheel.

6. The card reader according to claim 5, wherein
the worm wheel includes a worm wheel hole disposed at a center of the worm wheel,
the clutch rotation shaft is inserted in the worm wheel hole,
the clutch rotation shaft is configured such that in a case when the operation part is pressed, the clutch mechanism disengages power transmission between the worm wheel and the clutch rotation shaft via the clutch rotation shaft sliding inside the worm wheel hole such that the clutch rotation shaft side pin disengages from the gear side protrusion so that the worm wheel is rotatable around the clutch rotation shaft.

7. The card reader according to claim 6, wherein in a case when the operation part is pressed, a position of the clutch rotation shaft side pin is different from a position of the gear side protrusion in the clutch rotation axis direction of the clutch rotation shaft.

8. The card reader according to claim 7, further comprising:
a first plate;
a second plate, facing the first plate; and
a spacer, disposed between the second plate and the worm wheel.

9. The card reader according to claim 8, wherein in a case when the operation part is pressed, the worm wheel is configured to be rotatable relative to the clutch rotation shaft.

10. The card reader according to claim 9, wherein the elastic member is a compression coil spring.

11. The card reader according to claim 2, wherein
the worm wheel rotates about another rotation axis that is different from the clutch rotation axis.

12. The card reader according to claim 11, wherein
the worm wheel is not the two gears rotating around the clutch rotation axis.

13. The card reader according to claim 11, wherein
the first gear and the second gear are the two gears rotating around the clutch rotation axis,
the clutch gear decouplable from the clutch rotation shaft is the second gear, and the gear side protrusion is disposed on the second gear,
the first gear is fixed to the clutch rotation shaft.

14. The card reader according to claim 13, wherein the second gear is configured to rotate the clutch rotation shaft via the gear side protrusion of the second gear abutting the clutch rotation shaft side pin of the clutch rotation shaft.

15. The card reader according to claim 14, wherein
the first gear is fixed to the clutch rotation shaft, and
an elastic member, is disposed between the first gear and the second gear, and the elastic member biases the first gear in a direction away from the second gear.

16. The card reader according to claim 15, wherein
the second gear includes a second gear hole disposed at a center of the second gear,
the clutch rotation shaft is inserted in the second gear hole,
the clutch rotation shaft is configured such that in a case when the operation part is pressed, the clutch mechanism disengages power transmission between the second gear and the clutch rotation shaft via the clutch rotation shaft sliding inside the second gear hole such that the clutch rotation shaft side pin disengages from the gear side protrusion and the second gear is rotatable around the clutch rotation shaft.

17. The card reader according to claim 16, wherein in a case when the operation part is pressed, a position of the clutch rotation shaft side pin is different from a position of the gear side protrusion in an axial direction of the clutch rotation shaft.

18. The card reader according to claim 17, further comprising:
a first plate;
a second plate, facing the first plate; and
a spacer, disposed between the first plate and the second gear.

19. The card reader according to claim 18, wherein in a case when the operation part is pressed, the second gear is configured to be rotatable relative to the clutch rotation shaft.

20. The card reader according to claim 19, wherein the elastic member is a compression coil spring.
